(19) United States
(12) Patent Application Publication
(10) Pub. No.: US 2026/0046297 A1
(43) Pub. Date: Feb. 12, 2026

(54) METHOD AND SYSTEM FOR AUTONOMOUS ANOMALY DETECTION USING LM AGENTS

(71) Applicant: Booz Allen Hamilton Inc., McLean, VA (US)

(72) Inventors: John P. Sheehan, Arlington, VA (US); Ryan Swope, Philadelphia, PA (US); Jonathan Gaminde, Summerville, SC (US)

(73) Assignee: Booz Allen Hamilton Inc., McLean, VA (US)

(21) Appl. No.: 18/937,663

(22) Filed: Nov. 5, 2024

Related U.S. Application Data
(60) Provisional application No. 63/682,084, filed on Aug. 12, 2024.

(51) Int. Cl. H04L 9/40; G06F 16/22

(52) U.S. Cl. CPC H04L 63/1425; G06F 16/221

(57) ABSTRACT

Exemplary systems and methods conduct generate a plan for executing the anomaly detection operation without using or interacting with a secondary and/or external function or model. Any number of anomaly detection algorithms can be leveraged to generate a plan without human intervention or interaction. An LLM is trained to reason and autonomously identify anomalies in a dataset. The anomaly detection algorithms are arranged in a specified sequence to obtain a solution. Once the plan has been successfully executed, a self-reflection operation is performed to identify an flaws in the plan based on the goal or task. The plan is revised to mitigate any identified flaws. After one or more iterations of self-reflection and plan revision, a cohesive plan is obtained and is executed without errors and with successful anomaly detection/identification in the dataset.

### RELATED APPLICATIONS

This application claims priority to U.S. Provisional Application No. 63/682,084 filed on Aug. 12, 2024, the entire content of which is hereby incorporated by reference.

### FIELD

The present disclosure relates to methods and systems for autonomous anomaly detection using language model (LM) agents, such as large language model (LLM) agents.

### BACKGROUND

There are a variety of research papers regarding reinforcement learning, such as a paper referred to as Reflexion: (https://proceedings.neurips.cc/paper_files/paper/2023/file/1b44b878bb782e6954cd888 628510e90-Paper-Conference.pdf). This paper describes applying LLMs for “Verbal Reinforcement Learning” (VRL), essentially emulating actions a reinforcement learning algorithm might take but applying it in the space of LLMs to reason through a set of tasks in order to achieve an outcome, autonomously. The Reflexion paper supplements the LLM with a very specific “estimator” model that does the work a reinforcement learning algorithm would normally do-which is the score. However, Reflexion addresses very narrow tasks such as visual Question and Answer using a pre-made reinforcement learning (RL) algorithm from another open source library. It does not address the task of “anomaly detection.”

The Reflexion paper discloses use of a model framework known as ReAct. Libraries exist such as Langchain and BabyAGI libraries that incorporate LLM reasoning frameworks and code such as ReAct. ReAct (Reasoning and Agent action model) in and of itself, utilizes an LLM to respond to a series of templated, prompts. As a result, the ReAct framework is a recipe where the LLM follows a step-by-step problem solving approach to arrive at a goal by utilizing tools or application programming interfaces (APIs) to gather information and perform tasks. One example researches the internet to schedule a dinner reservation for the best Italian restaurant on a calendar.

### SUMMARY

An exemplary method for autonomous anomaly detection is disclosed. The method comprising: storing, by a memory device of a computing device, program code for performing autonomous anomaly detection; executing, by a processor of the computing device, the program code stored in memory, the processor causing the computing device to generate one or more applications and one or more trained neural network models for performing operations including: receiving, by a data interface of the computing device, data (live or static) from a data source; receiving, by a user interface of the computing device, a user prompt defining at least a context for the received data; analyzing, by the processor, the data with feature analysis processing based on the user prompt; generating, by the processor, a custom processing pipeline for detecting an anomaly in the data based on the user prompt, the custom processing pipeline including one or more algorithms for anomaly detection; passing, by the processor, the data through the custom processing pipeline to detect an anomaly based on the user prompt.

An exemplary system for autonomous anomaly detection is disclosed. The system comprising: a memory device configured to store program code for performing autonomous anomaly detection; a processor configured to execute the program code stored in memory, the processor configuring the system to generate one or more applications and one or more trained neural network models and causes the system to be configured to: receive, by a data interface, data from a data source; receive, by a user interface, a user prompt defining at least a context for the received data; analyze, by the processor, the data with feature analysis processing based on the user prompt; generate, by the processor, a custom processing pipeline for detecting an anomaly in the data based on the user prompt, the custom processing pipeline including one or more algorithms for anomaly detection; and pass, by the processor, the data through the custom processing pipeline to detect an anomaly based on the user prompt.

An exemplary non-transitory computer readable medium that stores program code for performing anomaly detection is disclosed, when placed in communicable contact with a computing system, the computer readable medium causes the computing system to be configured to: receive, by a data interface, data from a data source; receive, by a user interface, a user prompt defining at least a context for the received data; analyze, by the processor, the data with feature analysis processing based on the user prompt; generate, by the processor, a custom processing pipeline for detecting an anomaly in the data based on the user prompt, the custom processing pipeline including one or more algorithms for anomaly detection; and pass, by the processor, the data through the custom processing pipeline to detect an anomaly based on the user prompt.

### DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 illustrates a system for autonomous anomaly detection in accordance with an exemplary embodiment of the present disclosure.

FIG. 2 illustrates a data flow diagram in accordance with an exemplary embodiment of the present disclosure.

FIG. 3 illustrates a plan generation flow diagram in accordance with an exemplary embodiment of the present disclosure.

FIG. 4 illustrates a method for autonomous anomaly detection in accordance with an exemplary embodiment of the present disclosure.

FIGS. 5A and 5B illustrate a deep learning neural network in accordance with an exemplary embodiment of the present disclosure.

FIG. 6 illustrates a hardware configuration of a computing device in accordance with an exemplary embodiment of the present disclosure.

Further areas of applicability of the present disclosure will become apparent from the detailed description provided hereinafter. The detailed descriptions of exemplary embodiments are intended for illustration purposes only and are, therefore, not intended to necessarily limit the scope of the disclosure.

### DETAILED DESCRIPTION

Exemplary embodiments of the present disclosure are directed to a computing device that is configured to identify anomalies in network and time-series data using a trained large language model (LLM). The computing device receives a dataset and uses the LLM to analyze the dataset and generate a plan for processing the dataset to dataset to detect an anomaly. The LLM generates a series of predetermined prompts that support feature analysis, data processing, and anomaly detection utilizing calls to outside functions for executing algorithms to preprocess the data and detect anomalies.

According to an exemplary embodiment, the computing device can be configured to include a single LLM that includes short and long-term memory for storing processing results from which the LLM learns. The single LLM is configured to conduct autonomous anomaly detection task by generating a plan for executing the anomaly detection operation without using or interacting with a secondary and/or external function or model. An autonomous anomaly detection agent that can leverage any number of anomaly detection algorithms to generate a solution without human intervention or interaction. The agent receives the dataset and uses an LLM to reason and identify anomalies autonomously. In exemplary embodiments, an autonomous anomaly detection agent runs the specified gamut of anomaly detection algorithms in order to arrive at one solution on its own and without human intervention. Once the plan has been successfully executed, the LLM can self-reflect on the goal, the plan, and the outcome to try to find any flaws in the logic. If any flaws are discovered, the LLM can revise its plan to mitigate the flaws. After one or more iterations, the LLM agent can generate a cohesive plan that is executed without errors and with successful anomaly detection/identification in a dataset.

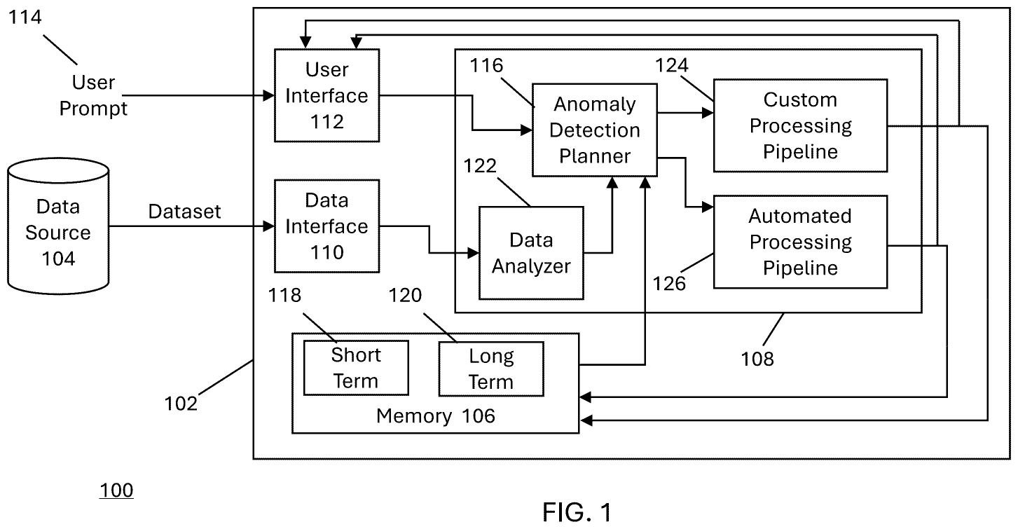

FIG. 1 illustrates a system for autonomous anomaly detection in accordance with an exemplary embodiment of the present disclosure. As shown in FIG. 1, the system 100 a computing device 102 configured for performing autonomous anomaly detection on a dataset. The system 100 also includes a data source 104 that provides the dataset to the computing device 102. The computing device 102 can include a memory device 106, a processor 108, a data interface 110, and a user interface 112. The memory device 106 is configured to store program code for performing autonomous anomaly detection. The processor 108 is configured to execute the program code stored in memory, so that the system can generate one or more applications and one or more trained neural network models and be configured to perform one or more operations for autonomous anomaly detection. The data interface 110 can include a combination of hardware and software components and be configured to receive data from the data source 104. According to exemplary embodiments of the present disclosure, the received data can include network data and/or time-series data. The data can be a structured or unstructured dataset in the form of a data table.

The user interface 112 can be configured to receive a user prompt 114 defining at least a context for the received data. The user prompt can also include an instruction for performing anomaly detection. According to an exemplary embodiment, the instruction for anomaly detection can also identify or define one or more specific anomalies to be detected in the data. It should be understood that identifying a specific anomaly to be detected is not necessary for performing anomaly detection according to the exemplary embodiments described herein. The user interface 112 can be a combination of hardware and software components that interact with a user by displaying or outputting content and/or receiving an input from the user. For example, the user interface 112 can include a display monitor, a touch screen device, a microphone, a keyboard, a mouse, a stylus or any other suitable device configured for user interaction as desired.

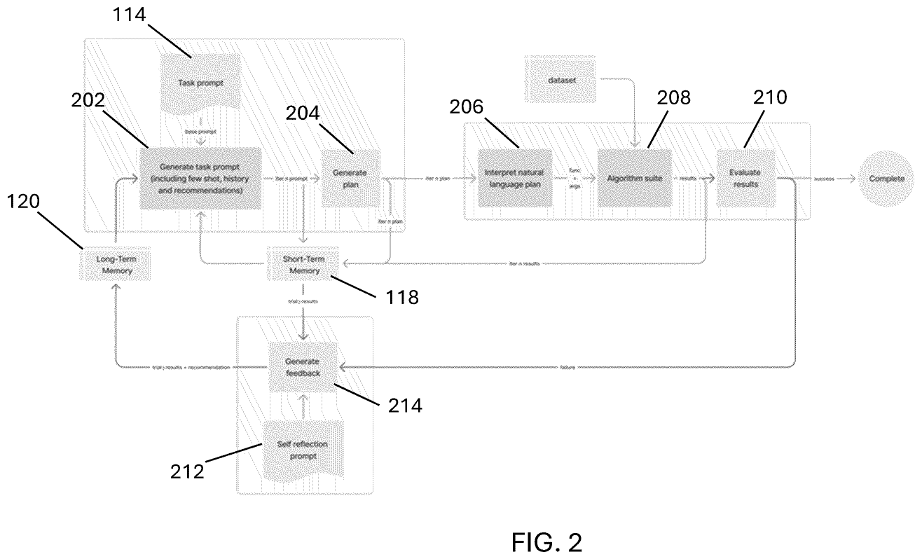

FIG. 2 illustrates a data flow diagram in accordance with an exemplary embodiment of the present disclosure. The processor 108 can be configured to include an anomaly detection planner 116 that generates a task prompt 202 based in-part on the user prompt 114. For example, the anomaly detection planner 116 can access historical information stored in short-term memory 118 and long-term memory 120. The historical information can include recommendations, determinations, and other processing information that the processor 108 determines is related to the current dataset and/or user prompt 114. For example, the anomaly detection planner 116 can search the short-term memory 118 and long-term memory 120 based on the user prompt 114 to access and/or obtain related historical information. The task prompt 202 can be stored in short-term memory 118 once it is generated. In addition, the anomaly detection planner 116 can generate a plan 204 for preprocessing the dataset to generate feature data and processing the feature data for identifying an anomaly based on the task prompt 202.

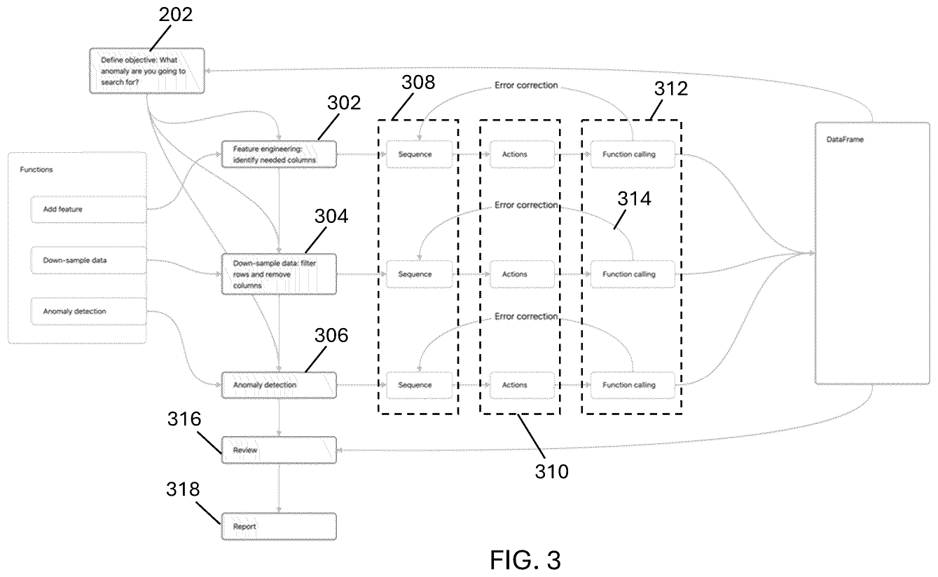

FIG. 3 illustrates a plan generation flow diagram in accordance with an exemplary embodiment of the present disclosure. The anomaly detection planner 116 can generate a plan for pre-processing the dataset to generate feature data and for processing the feature data for anomaly detection. According to an exemplary embodiment, the pre-processing operation(s) can include a feature engineering function 302 and a down-sampling function 304. The feature-engineering function 302 can be configured to manipulate the dataset to improve performance and accuracy in the anomaly detection. For example, the feature engineering and down-sampling operations can include at least one of adding one or more columns to the structured dataset, select one or more rows of the structured dataset; filter the data based on the data element contained in one or more rows of the dataset; group the selected one or more rows; and/or sort the data elements of one or more columns of the structured dataset. According to another exemplary embodiment, the feature engineering operations can include filtering, grouping, sorting, and/or any other suitable preprocessing operation performed on the structured or unstructured dataset as desired. The down-sampling operation 304 operates on the data such that one or more rows and/or columns of the dataset are filtered or removed based on anomaly to be detected. Further, the plan 204 can include an anomaly detection operation 306. For example, the anomaly detection planner 116 can identify one or more algorithms for analyzing the data to identify the anomaly.

For each of the feature engineering operation 302, the down-sampling operation 304, and the anomaly detection operation 306, the anomaly detection planner 116 can specify a sequence 308, actions 310, and function calling 312 for the operations to be performed. For example, for the feature engineering operation 302 the anomaly detection planner 116 can specify the order of operations to be performed on the dataset to add new columns to the dataset, the actions to be performed on the dataset to add new columns, such as, copying and/or extracting data from other columns to populate entries in the new column, and specifying functions to be called for performing the feature engineering operation according to the determined sequence and actions. For the down-sampling operation 304, the anomaly detection planner 116 can identify one or more filtering operations to be performed on rows and/or columns of the dataset, a sequence for performing the filtering operations, actions to be performed by the filtering operations, and specifying functions to be called for performing the down-sampling operation according to the determined sequence and actions. For the anomaly detection operation 306, the anomaly detection planner 116 can specify a sequence for arranging the one or more algorithms so that the data can be evaluated based on the task prompt 202, the actions to be performed by the one or more algorithms, and the functions to be called for performing the anomaly detection based on the determined sequence and actions. As will be discussed in greater detail, the anomaly detection planner 116 can perform error correction 314 on the sequencing of the algorithms if errors are detected in any of the feature engineering operation 302, the down-sampling operation 304, and the anomaly detection operation 306. Further, the results of the feature engineering operation 302, the down-sampling operation 304, and the anomaly detection operation 306 can be reviewed 316 during a self-reflection operation and report 318 generated which is saved in memory 106.

Turning back to FIG. 1, once the plan 204 is generated by the anomaly detection planner 116, the processor 108 can be configured to include a data analyzer 122 that executes the feature engineering operation 302, the down-sample operation 304, and the anomaly detection operation 306 according to the plan 204. As shown in FIG. 2, the data analyzer 122 interprets the plan 206 generated by the anomaly detection planner 116. For example, the data analyzer 122 interprets the natural language plan 204 including the feature engineering operation 302 and the down-sample operation 304 on the dataset. As already discussed, these pre-processing operation(s) can perform operations on the dataset for generating feature data that will be analyzed for anomaly detection.

The data analyzer 122 can further perform the anomaly detection operation 306 according to the plan 206 and configured to generate a custom processing pipeline 124 for detecting an anomaly in the data based on the user prompt 114. For example, the data analyzer 122 can select one or more predetermined and/or predefined algorithms (e.g., algorithm suite) 208 for anomaly detection from among a plurality of algorithms stored in accessible memory. The accessible memory can be a resident memory device, such as memory device 106 and/or an external memory device wirelessly or physically connected to the computing device 102. The data analyzer 122 can generate the custom processing pipeline 124 by arranging the selected one or more algorithms in a specified sequence for evaluating the data for an anomaly based on at least the context of the data defined in the user prompt 114. The data analyzer 122 can pass the pre-processed data through the custom processing pipeline 124 to detect an anomaly based on the initial user prompt 114 and evaluate the results 210. During processing of the data, the data analyzer 122 can send processing results at one of more stages and/or steps of the processing operation to the short-term memory 118.

The short-term memory 118 can be configured to store first processing results including a strategy used in generating the custom processing pipeline 124 and an outcome of each step in the sequence of steps. For example, the first processing results can include details and information related to the processing of a current dataset. The long-term memory 120 can be configured to store second processing results including a summary of anomaly detection results, user feedback identifying one or more flaws in at least one of logic and runtime, and recommendations for mitigating the one or more flaws in at least one of logic and runtime. For example, the second processing results can include information related to the processing results across plural or multiple prior datasets. According to an exemplary embodiment, the processor 108 can generate a new custom processing pipeline based on a new and/or revised user prompt 114 and using the first processing results stored in the short-term memory 118 and the second processing results stored in the long-term memory 120.

According to another exemplary embodiment, the processor 108 can be configured to initiate the processing of a current dataset in a subsequent or follow-up processing operation based on an error or failure in performing anomaly detection and based on the processing results stored in short-term memory 118. In addition, when a processing error or failure occurs during anomaly detection, the processor 108 can be configured to generate a self-reflection prompt 212 that initiates an operation in which the processor 108 evaluates the completed anomaly detection process based on the task 202 and the plan 204. For example, the processor 108 is configured to reflect on the task 202, the plan 204, and the outcome 210 to detect and/or identify a flaw or weakness in logic. If any are discovered, the processor 108 can generate feedback 214 for revising/modifying the task 202 and/or plan 204 to address the flawed and/or weak logic and improve anomaly detection for the user prompt 114. The processor 108 can store the feedback 214 generated from the reflection operation in long-term memory 120. The processor 108 can be configured to revise one or more steps in the sequence of steps used to process the current dataset based on the recommendations for mitigating the one or more flaws in at least one of logic and runtime stored in long-term memory 120. The processor 108 can then update the custom processing pipeline 118 used previously to process the current dataset with the revised one or more steps in the sequence of steps for processing the data for detecting an anomaly. This reflection operation 212 can be performed for one or more iterations, until an optimal plan has been successfully run in which an anomaly is identified and/or no flaws and/or weaknesses in logic are detected or identified. For example, the processor 108 can (iii) perform another iteration of anomaly detection using the updated custom processing pipeline, and repeat operations (i), (ii), and (iii) as needed until anomaly detection is performed successfully and at least one anomaly is identified in the data. The processor 108 can perform any of subsequent anomaly detection operations until the process can run without an error, an anomaly is detected in the dataset, or no flaws and/or weaknesses in logic are identified.

According to an exemplary embodiment, the processor 108 can be further configured to generate an automated processing pipeline 126 from one of the custom processing pipeline 118 or the updated custom processing pipeline when at least one of anomaly detection is performed successfully and at least one anomaly is identified. The processor 108 can perform anomaly detection using the automated processing pipeline 126 when new data is received from the data source.

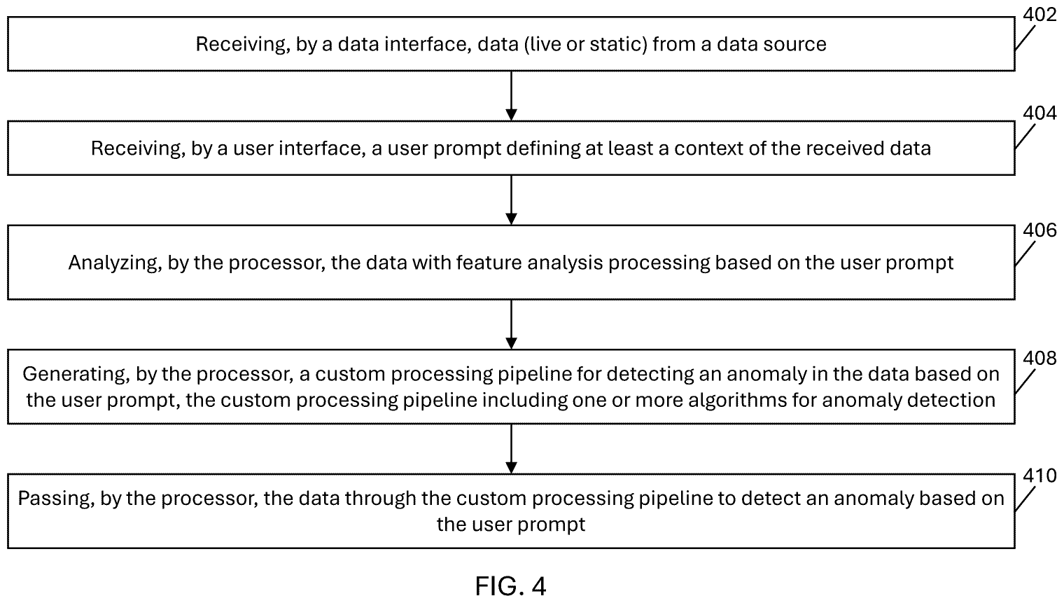

FIG. 4 illustrates a method for autonomous anomaly detection in accordance with an exemplary embodiment of the present disclosure. The method 400 can be performed by the processor 108 of the computing device 102. The processor executes program code for performing autonomous anomaly detection which is stored in the memory device 106 of the computing device 102. By executing the program code, the processor 108 causes the computing device 102 to generate one or more applications and one or more trained neural network models. Once configured by the program code, the computing device 102 can perform step 402 of the method 400 which includes receiving, by a data interface of the computing device, data from a data source. According to an exemplary embodiment, the data source includes one or more databases, and can store network data and/or time-series data in a structured or unstructured format, such as a data table. The computing device 102 receives, by the user interface 112, a user prompt 114 defining at least a context for the received data (Step 404). For example, if for example, the dataset includes information related visitors at a theme park, the user prompt 114 can be stated as follows:
The data provided is positional tracking for visitors at a theme park who attend a number of attractions throughout the day. Timestamp is the time the visitor's position was recorded. id is the visitor's id. X and Y are the visitor's position in the park in meters relative to the southwest corner of the park. The data is sorted by timestamp. Check-ins are recorded in the data as ‘type’==‘check-in’. No data is available while the visitors are checked into attractions. Your goal is to identify an anomalous activity or trend in this dataset.

After receiving the user prompt 114, the computing device 102 can perform step 406 which includes analyzing, by the processor 108, the received data with feature analysis processing based on the user prompt 114. According to an exemplary embodiment, and for a structured dataset such as a data table, the analyzing operation can include any one or a combination of (a) adding one or more columns to the structured data, (b) selecting one or more rows, (c) filtering the data based on the data element contained in one or more rows; (d) grouping the selected one or more rows, and (e) sorting the data elements of one or more columns. The method continues by the processor 108, generating a custom processing pipeline for detecting an anomaly in the data based on the user prompt 114 (Step 408). For example, the processor can perform the operations of selecting one or more algorithms configured for detecting an anomaly and arranging the selected one or more algorithms into a sequence of steps for processing the data for detecting an anomaly. At step 410, the processor 108 passes the data through the custom processing pipeline 124 to detect an anomaly based on the user prompt 114, which was used by the processor 108 to generate the task prompt 202 and the plan 204 for anomaly detection. During processing of the data by the custom processing pipeline, the processor 108 can store, by the memory 106 in a short-term memory location 118, first processing results including a strategy used in generating the custom processing pipeline 124 and an outcome of each step in the sequence of steps performed by the one or more algorithms. Further, the processor 108 can store, by the memory in a long-term memory location 120, second processing results including a summary of anomaly detection results, user feedback identifying one or more flaws in at least one of logic and runtime, and recommendations for mitigating the one or more flaws or weaknesses in logic, and/or runtime errors.

According to an exemplary embodiment, the processor 108 can generate a new custom processing pipeline based on a new user prompt 114 using the first processing results stored in the short-term memory location and the second processing results stored in the long-term memory location. For example, the processor can use the information obtained from short-term memory 118 and long-term memory 120 to generate a task prompt that improves performance in generating and executing a plan for anomaly detection.

According to another exemplary embodiment, if during anomaly detection, a run-time or other processing error occurs, the processor 108 can perform an analysis to determine a cause of the error. For example, the processor 108 can perform a critical analysis or self-reflection that focuses on a specific goal and plan as defined in the task prompt, and the outcome obtained from the anomaly detection operation to find any logical holes in the process. The processor can also perform self-reflection on a completed anomaly detection process to determine if any flaws or weaknesses in logic are present. If any runtime errors and/or flaws or weakness in logic are discovered, the processor 108 is prompted to revise the task prompt 202 and the plan 204 to address and mitigate the errors, flaws, and/or weaknesses. The processor 108 can use the self-reflection analysis to generate feedback to initiate the performance of operations including (i) revising one or more steps in the sequence of steps based on the recommendations for mitigating the one or more flaws in at least one of logic and runtime, (ii) updating the custom performance pipeline with the revised one or more steps in the sequence of steps for processing the data for detecting an anomaly, and (iii) performing another iteration of anomaly detection using the updated performance pipeline. The processor 108 can repeat steps (i) to (iii) until at least one of: anomaly detection is performed successfully and at least one anomaly is identified in the data. As a result, the processor 108, by virtue of executing the LLM, is prompted to “think” of an anomaly to look for based on at least the context of the data defined in the user prompt 114 and the results of prior data experiments.

According to another exemplary embodiment, whether an anomaly is detected in the data, the processor can successfully perform anomaly detection based on the user prompt 114 without any errors and/or without any flaws or weaknesses in logic being detected. Based on this result, the processor 108 can generate an automated processing pipeline 126 from one of the custom processing pipeline 124 or the updated processing pipeline when at least one of anomaly detection is performed successfully and at least one anomaly is identified. The processor 108 can perform anomaly detection using the automated processing pipeline 126 when new data is received from the data source 104. Anomaly detection by the automated processing pipeline 126 can be conducted in parallel with any custom processing pipeline 124 generated based on a new user prompt 114.

According to exemplary embodiments of the present disclosure, the processor 108 can be configured with one or more applications, such as an application programming interface, and/or a language model, such as a large language model (LLM) device artificial intelligence (AI) data Scientist (LLM-driven AI Data Scientist) model to perform the operations for anomaly detection as described herein.

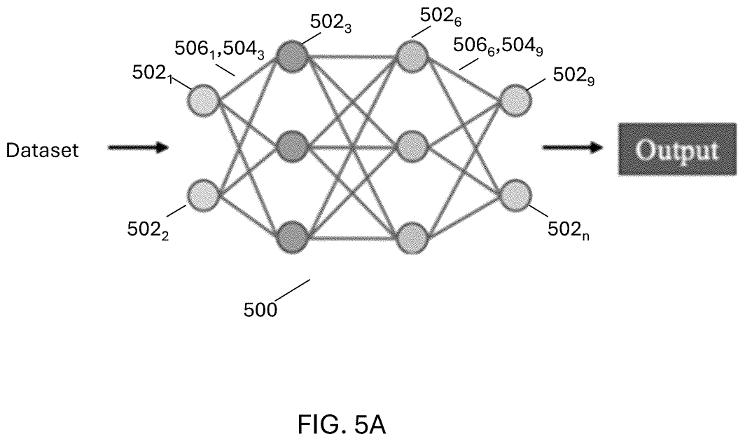

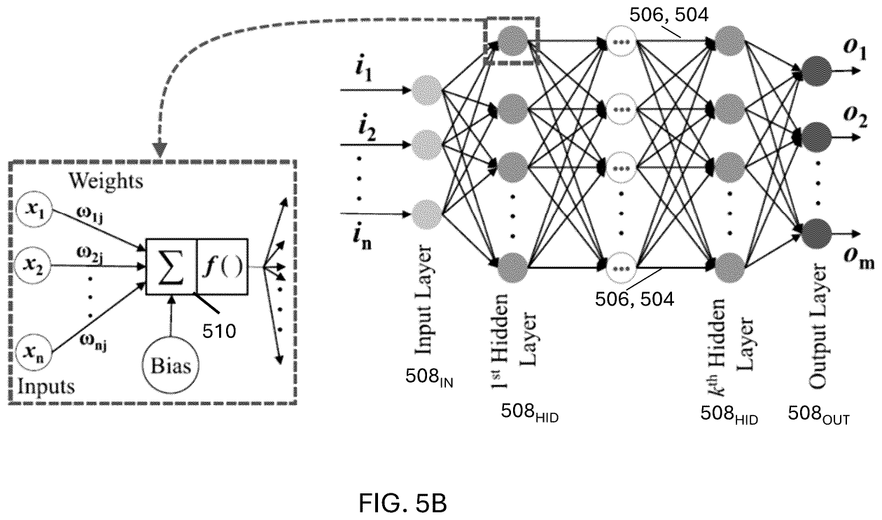

FIGS. 5A and 5B illustrate a deep learning neural network in accordance with an exemplary embodiment of the present disclosure. The system 100 can include a deep learning neural network architecture that processes based on textual summary that is generated from binary and/or. The textual summary can be initially generated as verbal feedback or self-reflective feedback obtained the environment which is converted into text to provide context for learning from prior processing tasks and improving performance in future processing tasks. The neural network can include plural nodes that represent individual computational units. Each node has one or more biased input/output connections that function as transfer or activation functions for combining the inputs and outputs in a specified manner. As shown in FIG. 5A the neural network 500 includes plural nodes 5021 to 502ₙ where each node 502ₙ has one or more inputs (i) 504 and outputs (o) 506 for processing the data. The neural network 500 is formed by an arrangement of the plural nodes 502ₙ into multiple layers 508, the scheme within which the nodes 502ₙ are connected determines the type and operation of the neural network 500. For example, as shown in FIG. 5B, the neural network 500 can include an input layer 508_{IN}, multiple hidden layers 508_{HID}, and an output layer 508_{OUT}. Each layer 508 may perform a different or specified transformation on the respective inputs, using a different or specified mathematical calculation or function. Signals travel or are passed between the layers 508, from the input layer 508_{IL} to the output layer 508_{OUT} via the middle or hidden layers 508_{HID} and can traverse any layer 508 and node(s) 502 multiple times. As shown in FIG. 5B, the nodes 502ₙ can be connected in an array and each node can transmit a signal to a node in another layer 508 of the neural network 500. The input/output connections 504,506 between the nodes have a corresponding weight wₙⱼ and are combined according to the bias applied at each node. For example, the connections 504,506 are activation or transfer functions which trigger the respective nodes and combine inputs according to mathematical equations or formulas 510 according to the bias. According to these neural network principles, and as shown in FIG. 5B, the data is received at an input layer 508_{IN} of the neural network 500 and passed through multiple hidden layers 508_{HID} for identifying an anomaly according to the task prompt. According to exemplary embodiments of the present disclosure, learning actions of the neural network are not achieved by updating weights. Rather, the neural network learns and optimizes data processing operations through self-reflective feedback already discussed.

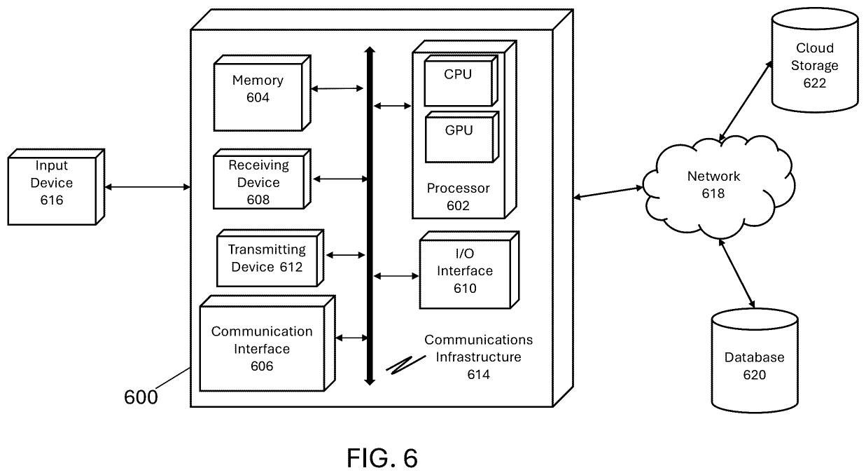

FIG. 6 illustrates a hardware configuration of a computing device in accordance with an exemplary embodiment of the present disclosure. As shown in FIG. 6, the computing system/device 600 may include a processor (e.g., CPU) 602 and memory 604. The processor 602 may execute software instructions (e.g., program code) for autonomous anomaly detection as disclosed herein. The computing system/device 600 as disclosed herein, can be configured for training one or more machine learning and/or artificial intelligence models (e.g., neural models, neural networks, and/or the like) and for autonomous anomaly detection with one or more trained machine learning models.

The processor 602 may be implemented in hardware, software, or a combination of hardware and software. For example, the processor 602 may include a Reduced Instruction Set Core (RISC) processor, a CISC microprocessor, a Microcontroller Unit (MCU), a CISC-based Central Processing Unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed and/or execute software instructions to perform a function. The hardware of such devices may be integrated onto a single substrate (e.g., silicon “die”), or distributed among two or more substrates. Various functional aspects of the processor 602 may be implemented solely as software or firmware associated with the processor 602.

Memory 604 may include random access memory (RAM), read-only memory (ROM), and/or another type of dynamic or static storage device (e.g., flash memory, magnetic memory, optical memory, etc.) that stores information and/or software instructions for use by the processor 602. Memory 604 may include a computer-readable medium and/or storage component. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 604 from another computer-readable medium or from another device via a communication interface with computing device. When executed, software instructions stored in memory may cause the processor to perform one or more processes described herein. Embodiments described herein are not limited to any specific combination of hardware circuitry and software.

The processor 602 can include one or more processing or operating modules. A processing or operating module can be a software or firmware operating module configured to implement any of the functions disclosed herein. The processing or operating module can be embodied as software and stored in memory 604. The memory 604 being operatively associated with and communicably coupled to the processor 602. A processing module can be embodied as a web application, a desktop application, a console application, etc.

The processor 602 can include or be associated with a computer or machine readable medium. The computer or machine readable medium can include memory. Any of the memory discussed herein can be computer readable memory configured to store data. The memory 604 can include a volatile or non-volatile, transitory, or non-transitory memory, and be embodied as an in-memory, an active memory, a cloud memory, etc. Examples of memory can include flash memory, Random Access Memory (RAM), Read Only Memory (ROM), Programmable Read only Memory (PROM), Erasable Programmable Read only Memory (EPROM), Electronically Erasable Programmable Read only Memory (EEPROM), FLASH-EPROM, Compact Disc (CD)-ROM, Digital Optical Disc DVD), optical storage, optical medium, a carrier wave, magnetic cassettes, magnetic tape, magnetic disk storage or other magnetic storage devices, or any other medium which can be used to store the desired information and which can accessed by the processor.

The memory 604 can be a non-transitory computer-readable medium. The term “computer-readable medium” (or “machine-readable medium”) as used herein is an extensible term that refers to any medium or any memory, which participates in providing instructions to the processor for execution, or any mechanism for storing or transmitting information in a form readable by a machine (e.g., a computer). Such a medium may store computer-executable instructions to be executed by a processing element and/or control logic, and data which is manipulated by a processing element and/or control logic, and may take many forms, including but not limited to, non-volatile medium, volatile medium, transmission media, etc. The computer or machine readable medium can be configured to store one or more instructions thereon. The instructions can be in the form of algorithms, program logic, etc. that cause the processor to execute any of the functions disclosed herein.

Embodiments of the memory 604 can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc. Communications can be via Bluetooth, near field communications, cellular communications, telemetry communications, Internet communications, etc.

Data stored in the exemplary computing device (e.g., in the memory) can be stored on any type of suitable computer readable media, such as optical storage (e.g., a compact disc, digital versatile disc, Blu-ray disc, etc.), magnetic tape storage (e.g., a hard disk drive), or solid-state drive. An operating system can also be stored in the memory.

In an exemplary embodiment, the data can be configured in any type of suitable database configuration, such as a relational database, a structured query language (SQL) database, a distributed database, an object database, etc. According to an exemplary embodiment, the data can be stored on one or more device configured to operate as cloud storage on a network. Suitable configurations and storage types will be apparent to persons having skill in the relevant art.

The exemplary computing device 600 can also include a communications interface 606. The communications interface 606 can be configured to allow software and data to be transferred between the computing device and external devices. Exemplary communications interfaces 606 can include a modem, a network interface (e.g., an Ethernet card), a communications port, a PCMCIA slot and card, etc. Software and data transferred via the communications interface 606 can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, etc. Transmission of data and signals can be via transmission media. Transmission media can include coaxial cables, copper wire, fiber optics, etc. Transmission media can also take the form of acoustic or light waves, such as those generated during radio-wave and infrared data communications, or other form of propagated signals (e.g., carrier waves, digital signals, etc.).

Memory semiconductors (e.g., DRAMs, etc.) can be means for providing software to the computing device. Computer programs (e.g., computer control logic) can be stored in the memory. Computer programs can also be received via the communications interface. Such computer programs, when executed, can enable computing device to implement the present methods as discussed herein. In particular, the computer programs stored on a non-transitory computer-readable medium, when executed, can enable hardware processor device to implement the methods as discussed herein. Accordingly, such computer programs can represent controllers of the computing device.

According to exemplary embodiments described herein, the combination of the memory 604 and the processor 602 can store and/or execute computer program code for performing the specialized functions described herein. The program code can be stored on a non-transitory computer readable medium, such as the memory devices for the computing device, which may be memory semiconductors (e.g., DRAMs, etc.) or other tangible and non-transitory means for providing software to the computing device. For example, via any known or suitable service or platform, the program code can be deployed (e.g., streamed and/or downloaded) remotely from computing devices located on a local-area or wide-area network and/or in a cloud-computing arrangement or environment. In another example, the computer programs (e.g., computer control logic) or software may be stored in memory resident on/in the computing device. The computer programs or software may be stored in a computer program product or non-transitory computer readable medium and loaded into the computing device using any one or combination of a removable storage drive, an interface for internal or external communication, and a hard disk drive, where applicable. The computer programs or software, when executed, may enable the computing device to implement the present methods and exemplary embodiments discussed herein. Accordingly, such computer programs may represent controllers of the computing device.

The computing system 600 or device may also include a receiver or receiving device 608, an input/output (I/O) interface 610, a transmitting device 612, a communication infrastructure 614, an input device 616, a communication network 618, and a database 620 and/or cloud storage 624.

The receiver or receiving device 608 may be a combination of hardware and software components configured to receive data samples from the mobile network or database. According to exemplary embodiments, the receiving device 608 can include a hardware component such as an antenna, a network interface (e.g., an Ethernet card), a communications port, a Personal Computer Memory Card International Association (PCMCIA) slot and card, 5G New Radio (NR) interface, or any other component or device suitable for use on a mobile communication network or Radio Access Network as desired. The receiving device 608 can be an input device for receiving signals and/or data samples formatted according to 3GPP protocols and/or standards. The receiving device 608 can be connected to other devices via a wired or wireless network or via a wired or wireless direct link or peer-to-peer connection without an intermediate device or access point. The hardware and software components of the receiving device 608 can be configured to receive the data from the mobile network according to one or more communication protocols and data formats. For example, the receiving device 608 can be configured to communicate over a network 620, which may include a local area network (LAN), a wide area network (WAN), a wireless network (e.g., Wi-Fi), a mobile communication network, a satellite network, the Internet, fiber optic cable, coaxial cable, infrared, radio frequency (RF), another suitable communication medium as desired, or any combination thereof. During a receive operation, the receiving device 608 can be configured to identify parts of the received data via a header and parse the data signal and/or data packet into small frames (e.g., bytes, words) or segments for further processing at the processor.

The I/O interface 610 can be configured to receive the signal from the processor and generate an output suitable for a peripheral device via a direct wired or wireless link. The I/O interface 610 can include a combination of hardware and software for example, a processor, circuit card, or any other suitable hardware device encoded with program code, software, and/or firmware for communicating with a peripheral device such as a display device, printer, audio output device, or other suitable electronic device or output type as desired.

The transmitting device 612 can be configured to receive data from the processor and assemble the data into a data signal and/or data packets according to the specified communication protocol and data format of a peripheral device or remote device to which the data is to be sent. The transmitting device 612 can include any one or more of hardware and software components for generating and communicating the data signal over the communications infrastructure and/or via a direct wired or wireless link to a peripheral or remote device. The transmitting device 612 can be configured to transmit information according to one or more communication protocols and data formats as discussed in connection with the receiving device.

The input device 616 is configured to receive an input from a user for processing and/or use by the CPU 602. For example, the input device 618 can be implemented as a physical or virtual keyboard, a physical or virtual touchpad, a microphone, or any suitable device for inputting data or information as desired. The input device 616 can be configured to format the received user input suitable for use by the CPU 602 or be configured to provide the user input to the I/O interface 610 for further processing. According to an exemplary embodiment, the input device 616 can be configured to communicate wirelessly with the computing system 600 or be integrated into the housing of the computing system 600 or have a physical connection to the computing device 600. In performing the described operations, the input device 616 can be configured to include a combination of hardware and software components.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processors (e.g., by a compiling module or engine) prior to execution. For example, the program code may be source code written in a programming language that is translated into a lower level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling the system to perform the functions disclosed herein. It will be apparent to persons having skill in the relevant art that such processes result in the system being a specially configured computing device uniquely programmed to perform the functions of the exemplary embodiments described herein.

It will be appreciated by those skilled in the art that the present disclosure can be embodied in other specific forms without departing from the spirit or essential characteristics thereof. The presently disclosed embodiments are therefore considered in all respects to be illustrative and not restrictive. The scope of the disclosure is indicated by the appended claims rather than the foregoing description, and all changes that come within the meaning, range, and equivalence thereof are intended to be embraced therein.

What is claimed is:

1. A method for autonomous anomaly detection, comprising:
storing, by a memory device of a computing device, program code for performing autonomous anomaly detection;
executing, by a processor of the computing device, the program code stored in memory, the processor causing the computing device to generate one or more applications and one or more trained neural network models for performing operations including:
receiving, by a data interface of the computing device, data (live or static) from a data source;
receiving, by a user interface of the computing device, a user prompt defining at least a context for the received data;
analyzing, by the processor, the data with feature analysis processing based on the user prompt;
generating, by the processor, a custom processing pipeline for detecting an anomaly in the data based on the user prompt, the custom processing pipeline including one or more algorithms for anomaly detection;
passing, by the processor, the data through the custom processing pipeline to detect an anomaly based on the user prompt.

2. The method of claim 1, wherein the data source includes one or more databases.

3. The method of claim 1, wherein the one or more databases store plural data tables.

4. The method of claim 3, wherein the structured data is a table and analyzing the data includes at least one of:
(a) adding one or more columns to the structured data;
(b) selecting one or more rows;
(c) filtering the data based on the data element contained in one or more rows; and
(d) grouping the selected one or more rows; and
(e) sorting the data elements of one or more columns,
wherein each of (a) to (e) is performed based on the user prompt.

5. The method of claim 1, wherein generating the custom processing pipeline, comprises:
selecting one or more algorithms configured for detecting an anomaly; and
arranging the selected one or more algorithms into a sequence of steps for processing the data for detecting an anomaly.

6. The method of claim 5, further comprising:
storing, by the memory in a short-term memory location, first processing results including a strategy used in generating the custom processing pipeline and an outcome of each step in the sequence of steps.

7. The method of claim 6, further comprising:
storing, by the memory in a long-term memory location, second processing results including a summary of anomaly detection results, user feedback identifying one or more flaws in at least one of logic and runtime, and recommendations for mitigating the one or more flaws in at least one of logic and runtime.

8. The method of claim 7, further comprising:
generating a new custom processing pipeline based on a new user prompt and using the first processing results stored in the short-term memory location and the second processing results stored in the long-term memory location.

9. The method of claim 7, further comprising:
(i) revising one or more steps in the sequence of steps based on the recommendations for mitigating the one or more flaws in at least one of logic and runtime;
(ii) updating the custom performance pipeline with the revised one or more steps in the sequence of steps for processing the data for detecting an anomaly;
(iii) performing another iteration of anomaly detection using the updated performance pipeline; and
(iv) repeating steps (i) to (iii) until at least one of: anomaly detection is performed successfully and at least one anomaly is identified in the data.

10. The method of claim 9, further comprising:
generating an automated processing pipeline from one of the custom processing pipeline or the updated processing pipeline when at least one of anomaly detection is performed successfully and at least one anomaly is identified; and
performing anomaly detection using the automated processing pipeline when new data is received from the data source.

11. A system for autonomous anomaly detection, comprising:
a memory device configured to store program code for performing autonomous anomaly detection;
a processor configured to execute the program code stored in memory, the processor configuring the system to generate one or more applications and one or more trained neural network models and causes the system to be configured to:
receive, by a data interface, data (live or static) from a data source;
receive, by a user interface, a user prompt defining at least a context for the received data;
analyze, by the processor, the data with feature analysis processing based on the user prompt;
generate, by the processor, a custom processing pipeline for detecting an anomaly in the data based on the user prompt, the custom processing pipeline including one or more algorithms for anomaly detection; and
pass, by the processor, the data through the custom processing pipeline to detect an anomaly based on the user prompt.

12. The system of claim 11, wherein the structured data is a table, and the processor is configured to:
(a) add one or more columns to the structured data;
(b) select one or more rows of the structured data;
(c) filter the data based on the data element contained in one or more rows;
(d) group the selected one or more rows; and/or
(e) sort the data elements of one or more columns,
wherein each of (a) to (e) is performed based on the user prompt.

13. The method of claim 11, wherein the processor causes the system to be configured to:
select one or more algorithms configured for detecting an anomaly; and
arrange the selected one or more algorithms into a sequence of steps for processing the data for detecting an anomaly.

14. The system of claim 13, wherein the processor causes the system to be configured to:
store, by the memory in a short-term memory location, first processing results including a strategy used in generating the custom processing pipeline and an outcome of each step in the sequence of steps.

15. The system of claim of claim 14, wherein the processor causes the system to be configured to:
store, by the memory in a long-term memory location, second processing results including a summary of anomaly detection results, user feedback identifying one or more flaws in at least one of logic and runtime, and recommendations for mitigating the one or more flaws in at least one of logic and runtime.

16. The system of claim 15, wherein the processor causes the system to be configured to:
generate a new custom processing pipeline based on a new user prompt and using the first processing results stored in the short-term memory location and the second processing results stored in the long-term memory location.

17. The system of claim 15, wherein the processor causes the system to be configured to:
(i) revise one or more steps in the sequence of steps based on the recommendations for mitigating the one or more flaws in at least one of logic and runtime;
(ii) update the custom performance pipeline with the revised one or more steps in the sequence of steps for processing the data for detecting an anomaly;
(iii) perform another iteration of anomaly detection using the updated performance pipeline; and
(iv) repeat steps (i) to (iii) until at least one of: anomaly detection is performed successfully and at least one anomaly is identified in the data.

18. The system of claim 17, wherein the processor causes the system to be configured to:
generate an automated processing pipeline from one of the custom processing pipeline or the updated processing pipeline when at least one of anomaly detection is performed successfully and at least one anomaly is identified; and
perform anomaly detection using the automated processing pipeline when new data is received from the data source.

19. A non-transitory computer readable medium that stores program code for performing anomaly detection, when placed in communicable contact with a computing system, the computer readable medium causes the computing system to be configured to:
receive, by a data interface, data (live or static) from a data source;
receive, by a user interface, a user prompt defining at least a context for the received data;
analyze, by the processor, the data with feature analysis processing based on the user prompt;
generate, by the processor, a custom processing pipeline for detecting an anomaly in the data based on the user prompt, the custom processing pipeline including one or more algorithms for anomaly detection; and
pass, by the processor, the data through the custom processing pipeline to detect an anomaly based on the user prompt.
